(19) United States
(12) Patent Application Publication
(10) Pub. No.: US 2023/0251865 A1
(43) Pub. Date: Aug. 10, 2023

(54) SPEED SETTINGS FOR INTERFACES CONNECTED TO PREVIOUS GENERATION CARRIERS

(71) Applicant: HEWLETT-PACKARD DEVELOPMENT COMPANY, L.P., Spring, TX (US)

(72) Inventors: CHAO-WEN CHENG, Taipei City (TW); WEN SHIH CHEN, Taipei City (TW); CHEN-PANG CHANG, Taipei City (TW); YI-FENG LIN, Taipei City (TW)

(21) Appl. No.: 17/667,872

(22) Filed: Feb. 9, 2022

(51) Int. Cl. G06F 9/4401; G06F 13/40; G06F 13/16

(52) U.S. Cl. CPC G06F 9/4401; G06F 13/4063; G06F 13/16; G06F 2213/0026

(57) ABSTRACT

In example implementations, an apparatus is provided. The apparatus includes an interface, a previous generation carrier connected to the interface, a controller communicatively coupled to the interface, and a basic input/output system (BIOS). The previous generation carrier includes a current generation memory card. The controller is to detect the previous generation carrier. The BIOS is to set the interface to operate at a speed associated with the previous generation carrier in response to detection of the previous generation carrier.

### BACKGROUND

Computing devices can be used to execute various applications and programs. A processor is deployed in a computing device to execute the applications and programs. The computing device can have additional components that can help execute the applications, such as memory, graphics processors, and the like.

Certain connection interfaces on a printed circuit board of the computing device may provide flexibility in the types of peripheral devices that can be connected. For example, peripheral component interconnect express (PCIe) interfaces can be used to connect to different types of add-in-cards, such as a discrete graphics cards, additional memory cards, and the like.

### BRIEF DESCRIPTION OF THE DRAWINGS

FIG. 1 is a block diagram of an example an apparatus of the present disclosure;

FIG. 2 is a more detailed block diagram of the carrier coupled to an interface of the present disclosure;

FIG. 3 is a block diagram of an example boot operation performed by a basic input/output system (BIOS) to assign a proper speed allocation to an interface connected to a previous generation carrier of the present disclosure;

FIG. 4 is a flow chart of an example method to control a speed allocation for a speed allocation for a current generation interface connected to a previous generation carrier of the present disclosure; and

FIG. 5 is an example non-transitory computer readable storage medium storing instructions executed by a processor to control a speed allocation for a current generation interface connected to a previous generation carrier of the present disclosure.

### DETAILED DESCRIPTION

Examples described herein provide an apparatus and method to provide adaptive speed allocation for an interface bus that is connected to a previous generation carrier. As discussed above, computing devices can be used to execute various applications and programs. Certain connection interfaces on a printed circuit board of a computing device may provide flexibility in the types of peripheral devices that can be connected. For example, peripheral component interconnect express (PCIe) interfaces can be used to connect to different types of add-in-cards, such as a discrete graphics cards, additional memory cards, and the like.

A carrier can be used to provide a removable non-volatile memory express (NVME) drive for a computing device. The carrier can be connected to a PCIe interface on the computing device.

A current generation of NVME memory devices is a fourth generation (Gen4). Example Gen4 NVME memory devices can read at speeds up to 5000 megabytes per second (MB/s) and write at speeds up to 4400 MB/s. A previous generation of NVME memory devices is a third generation (Gen3). Gen3 NVME memory devices read and write at speeds that are slower than Gen4. For example, Gen3 NVME memory cards can read at speeds up to 3500 MB/s and write at speeds up to 3300 MB/s.

Current carriers use a Gen3 interface. Thus, the carriers operate at Gen3 speeds. The Gen4 NVME memory cards are backwards compatible and can be used in the Gen3 carriers. However, when a Gen3 carrier with a Gen4 NVME memory card is inserted into a Gen4 interface of a computing device, the mismatch can create instability. For example, the computing device may try to operate at Gen4 speeds, which cannot be handled by the Gen3 carriers.

The present disclosure allows a basic input/output system (BIOS) of a computing system to detect whether an interface bus is connected to a Gen4 drive or a Gen3 carrier. If the interface bus is connected to a Gen4 drive, then the BIOS can train the interface bus to operate at Gen4 speeds. However, if the interface bus is connected to a Gen3 carrier, then the BIOS can train the interface bus to operate at Gen 3 speeds. Thus, the interface bus can set to operate properly depending on a type of device that is connected to the interface bus that is detected when the computing device is booted up.

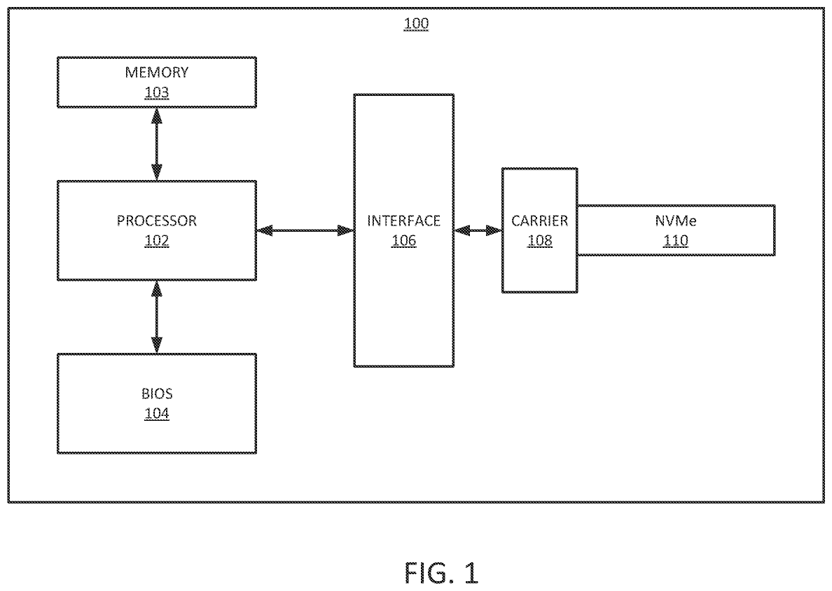

FIG. 1 illustrates an example apparatus 100 of the present disclosure. In an example, the apparatus 100 may be a computing device or computing system. For example, the apparatus 100 may be a desktop computer, a laptop computer, a tablet computer, and the like.

It should be noted that apparatus 100 has been simplified for ease of explanation. Although various example components are illustrated in FIG. 1, it should be noted that the apparatus 100 may include additional components that are not shown. For example, the apparatus 100 may include input/output devices (e.g., a display, a monitor, a keyboard, a mouse, a trackpad, and the like), a power supply, various interfaces (e.g., a universal serial bus (USB) interface), communications interfaces (e.g., a wired or wireless communication interface such as WiFi, Ethernet, and the like), and so forth.

In an example, the apparatus 100 may include a processor 102, a memory 103, a basic input/output system (BIOS) 104, an interface 106, and a carrier 108. The processor 102 may be communicatively coupled to the memory 103, the BIOS 104 and the interface 106. The processor 102 may execute instructions stored in the BIOS 104 and instructions stored in the memory 103 to perform the functions described herein.

As used herein, a BIOS refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of the computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In an example, the processor 102 may be a controller of the interface 106. For example, the processor 102 may be an embedded controller that can detect the types of devices that are connected to the slots of the interface 106. In an example, the embedded controller may be a super input/output (SIO) controller used in a desktop or a board management controller (BMC) that can be used in more powerful server applications.

In an example, the memory 103 may be any type of non-transitory computer readable medium. The memory 103 may be a random access memory (RAM), a read only memory (ROM), a hard disk drive, a solid state drive, a non-volatile memory express (NVMe) drive, and the like. Although a single memory 103 is illustrated in FIG. 1, it should be noted that the memory 103 may be deployed as a plurality of different types of memory 103.

In an example, the interface 106 may be peripheral component interconnect express (PCIe) interface. The interface 106 may be a current generation interface. For example, the interface 106 may use the latest communication protocols to provide the highest possible data transfer rates across the interface 106. In an example, the current generation may be a fourth generation (Gen4) interface.

In an example, the carrier 108 may be connected to a memory device 110. In an example, the memory device 110 may be a non-volatile memory express (NVMe) drive. The memory device 110 may also be a current generation memory device (e.g., Gen4 device).

The carrier 108 may allow certain types of memory devices 110 to be connected to the apparatus 100 as an expansion drive or a portable memory device. However, the carrier 108 is not available with the current generation communication protocols (e.g., Gen4). Rather, the carrier 108 may be a previous generation carrier. That is, the carrier 108 may use communication protocols that are older (e.g., a third generation (Gen3)) than the communication protocols used by the current generation interface 106.

Gen4 devices may operate at a read speeds up to 5000 megabytes per second (MB/s) and write speeds up to 4400 MB/s. Gen3 devices may operate at read speeds of less than 3500 MB/s and write speeds up to 3300 MB/s. Thus, trying to operate Gen3 devices at Gen4 speeds may cause data transfer errors or cause a malfunction during operation of the Gen3 device connected to a Gen4 interface.

Although the examples herein describe the use of Gen3 as a previous generation communication protocol and Gen4 as a current generation communication protocol, it should be noted that “previous generation” and “current generation” may refer to other generation communication protocols based on the most up-to-date communication protocol. For example, in the future, Gen5 communication protocols may be released. Thus, Gen4 may become a previous generation communication protocol and Gen5 may become the current generation communication protocol.

In addition, previous generation communication protocols may include communication protocols that are more than one generation older than the current generation communication protocol. For example, in the future, Gen5 communication protocols may be released. However, the previous generation communication protocol may still refer to the Gen3 communication protocol used for the carriers of the Gen 4 or Gen5 drives.

To illustrate, when the memory device 110 attempts to transmit or receive data via the carrier 108 connected to the interface 106, errors may occur. For example, the apparatus 100 may attempt to transmit data using a current generation communication protocol to use the highest data speeds available, but the carrier 108 may be unable to understand the current generation communication protocol since it is a previous generation carrier.

The present disclosure modifies the BIOS 104 to allow the BIOS 104 to re-train the interface 106 based on the type of device that is connected to the interface 106. For example, if the BIOS 104 detects a current generation memory device connected to the interface 106, the BIOS 104 may train the interface 106 to use the current generation protocols.

However, if the BIOS 104 detects a previous generation device (e.g., the previous generation carrier 108), the BIOS 104 may re-train the interface 106 to use the previous generation protocols. For example, the interface 106 (or a slot of the interface 106) may be retrained to operate at a read speed associated with the previous generation protocols (e.g., Gen3) of 3500 MB/s and a write speed up to 3300 MB/s, which is down from a maximum read speed of up to 5000 MB/s and a maximum write speed of up to 4400 MB/s. Thus, data transfer errors and/or malfunctions may be eliminated due to a mismatch of current generation protocols.

In an example, the interface 106 may include a plurality of slots. Thus, the BIOS 104 may detect the type of device connected to each slot of the interface 106 and train each slot of the interface 106 accordingly. For example, a first slot may have the carrier 108. The BIOS 104 may train the first slot to use a Gen3 protocol that is compatible with the Gen3 carrier 108.

A second slot may have a Gen4 memory device directly inserted into the second slot. As a result, the BIOS 104 may train the second slot to use a Gen4 protocol that is compatible with the Gen4 memory device in the second slot, and so forth.

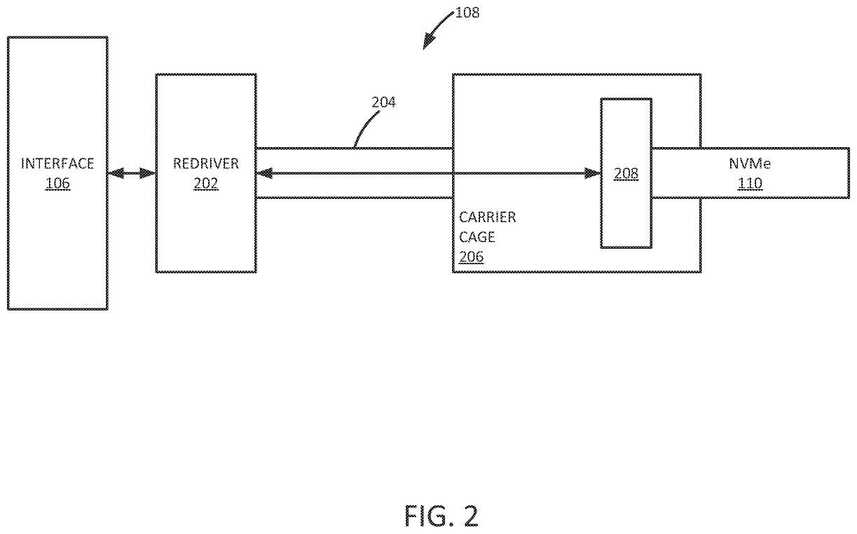

FIG. 2 illustrates a more detailed block diagram of the carrier 108 connected to the interface 106 and the memory device 110. In an example, the carrier 108 includes a redriver 202, a cable 204, and a carrier cage 206. The carrier cage 206 may include an interface 208. The memory device 110 may be inserted into the carrier cage 206 and connected to the interface 208. The interface 208 may use connections that are compatible with the memory device 110 (e.g., a M.2 connection interface).

The cable 204 may communicatively couple the redriver 202 to the carrier cage 206 and the interface 208. The cable 204 may carry data from the memory device 110 to the interface 106 or vice versa.

The redriver 202 may be used to amplify, retime, or repeat a signal for transmission to the NVME 110. For example, the signals transmitted by the interface 106 may be intended for devices that are directly connected to the interface 106. Thus, the signals may not be strong enough to travel across longer distances or across multiple components. The redriver 202 may amplify or retime the signal from the interface 106 such that the signal can travel across the cable 204, through the carrier cage 206 and to the interface 208 to be received by the memory device 110.

In an example, the redriver 202 may have a repeater identification (ID). In an example, when the carrier 108 is connected to the interface 106, the processor 102 may read the repeater ID of the redriver 202. The repeater ID may allow the processor 102 and/or the BIOS 104 to know that the device connected to the interface 106 is a previous generation carrier 108 (e.g., a Gen3 carrier) and not a current generation component (e.g., a Gen4 memory device or graphics card).

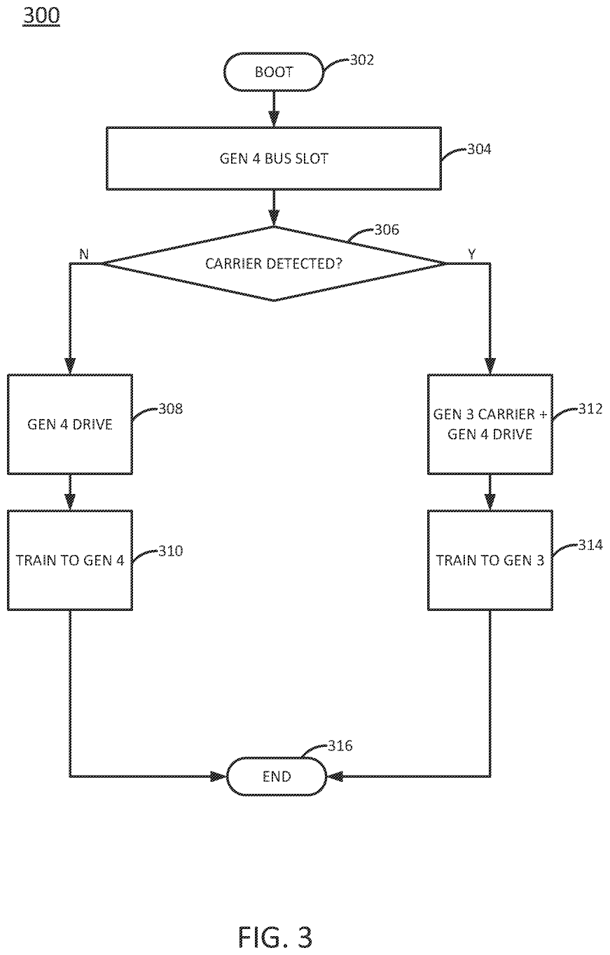

FIG. 3 illustrates a block diagram of an example boot operation 300 performed by the BIOS 104 to assign a proper speed allocation to the interface 106 connected to a previous generation carrier 108 of the present disclosure. For example, at block 302, the computing device may be booted. During the boot sequence the BIOS 104 may be executed to initialize the drivers and/or settings for various interfaces and components within the computing device.

At block 304, the boot operation 300 may scan the Gen4 bus slots of the interface (e.g., the PCIe interface). In some instances, a host controller of the interface can detect which slots are connected to a device and provide connection information to the BIOS.

At block 306, the boot operation 300 may determine if a previous generation carrier is detected. For example, the boot sequence 300 may attempt to read the repeater ID for the slots that are detected to have connections. If a repeater ID is not read on a slot (e.g., the answer to block 306 is no), the boot operation 300 may proceed to block 308.

At block 308, the boot operation 300 may determine that a Gen4 drive is connected to the Gen4 bus slot. At block 310, the boot operation 300 may train the Gen4 bus slot to use Gen4 protocols to transfer data.

Referring back to block 306, if a repeater ID is read for a slot, then the boot operation 300 may determine that a previous generation carrier is connected to the Gen4 bus slot.

At block 312, the boot operation 300 may determine that a Gen3 carrier is connected to the Gen4 bus slot. The Gen3 carrier may be connected to a Gen4 drive. As noted above, the Gen3 carrier may allow certain memory devices to be used as portable drives or expansion drives for computing systems. However, these carriers are not available with Gen4 protocols.

At block 314, the boot operation 300 may train the Gen4 bus slot to use Gen3 protocols. Thus, the Gen4 bus slot connected to the Gen3 carrier may operate at slower data transmission speeds associated with the Gen3 protocols to prevent data transmission errors due to a protocol speed mismatch. At block 316, the boot operation 300 ends.

In an example, the boot operation 300 may be performed each time the computing device is restarted or powered on. Thus, when the carrier cage is removed or replaced, the computing device can be restarted. The boot operation 300 may detect when the Gen3 carrier is removed or replaced with a Gen4 drive and re-train the Gen4 bus slot to use the Gen4 protocols.

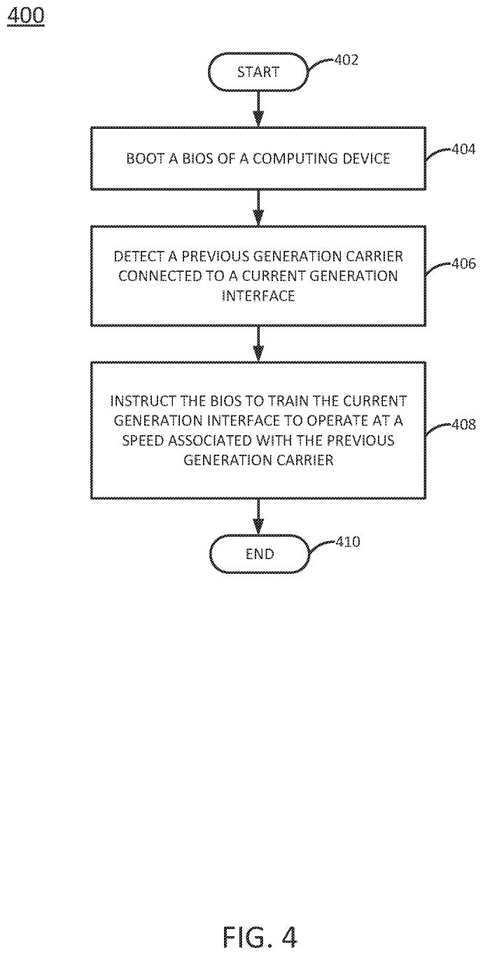

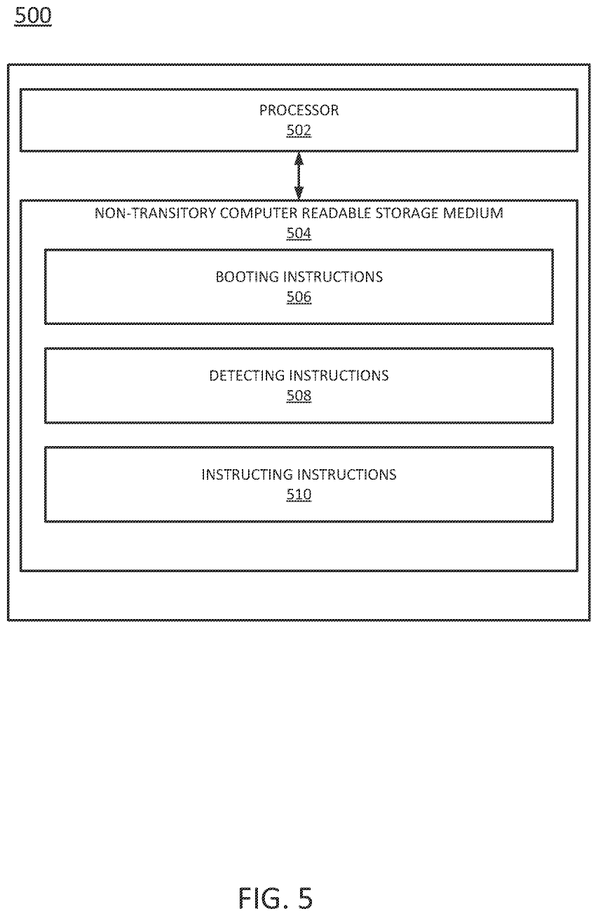

FIG. 4 illustrates a flow diagram of an example method 400 for controlling a speed allocation for a current generation interface connected to a previous generation carrier of the present disclosure. In an example, the method 400 may be performed by the apparatus 100 illustrated in FIG. 1 or the apparatus 500 illustrated in FIG. 5, and described below.

At block 402, the method 400 begins. At block 404, the method 400 boots a basic input/output system (BIOS) of a computing device. The BIOS may be executed when the computing device is restarted or powered on. The BIOS may execute various drivers or instructions to initialize and/or configure various interfaces or components of the computing device for operation with the operating system of the computing device.

In an example, the BIOS can be executed to set speeds for an interface. The interface may be a PCIe interface. The speeds can be set for each slot of the PCIe interface based on a type of device or component that is connected to each slot of the PCIe interface to ensure speed compatibility and proper transmission of data between the PCIe interface and the device that is connected.

At block 406, the method 400 detects a previous generation carrier connected to a current generation interface. In an example, the slots of the interface may be scanned to determine which slots are connected to a device. For the slots that are connected to a device, the computing device may request information from the device to try to determine what type of device is connected to the interface.

In an example, when a repeater ID is read, the computing device may determine that a previous generation carrier is connected to the current generation interface. For example, the repeater ID may be provided by a redriver that is part of the previous generation carrier. The repeater ID may identify the device as being a previous generation carrier.

At block 408, the method 400 instructs the BIOS to train the current generation interface to operate at a speed associated with the previous generation carrier. In response to detecting the previous generation carrier connected to the current generation interface, the BIOS may set the speed of the current generation interface to use a speed associated with the previous generation carrier.

For example, the current generation interface may have slots that use a Gen4 protocol that have the highest available data transfer speeds. The previous generation carrier may use a Gen3 protocol that is older than the Gen4 protocol can provide maximum speeds that are slower than the speeds associated with the Gen4 protocol. The BIOS may set the maximum speed of the current generation interface, or the slot connected to the previous generation carrier, to the maximum speeds associated with the Gen3 protocol. Thus, the current generation interface may be ensured to work properly with the previous generation carrier.

In an example, when the previous generation carrier is replaced with a current generation drive, the BIOS may change the speed setting of the current generation interface back to using the current generation protocols or speeds. For example, the computing device may be powered down to replace the previous generation carrier with a current generation memory device (e.g., a Gen4 memory device).

The BIOS of the computing device may be booted to initialize or configure the various interfaces and/or components of the computing device. The current generation memory device connected to the current generation interface may be detected. The BIOS may be instructed to train the current generation interface to operate at a speed associated with the current generation memory device. In other words, the speed of the current generation interface may be changed from operating at the slower speeds associated with the previous generation carrier, back to the faster speeds associated with the current generation memory device that is being used without the previous generation carrier. At block 410, the method 400 ends.

FIG. 5 illustrates an example of an apparatus 500. In an example, the apparatus 500 may be the apparatus 100. In an example, the apparatus 500 may include a processor 502 and a non-transitory computer readable storage medium 504. The non-transitory computer readable storage medium 504 may include instructions 506, 508, and 510 that, when executed by the processor 502, cause the processor 502 to perform various functions.

In an example, the instructions 506 may include booting instructions 506. For example, the instructions 506 may boot a basic input/output system (BIOS) of a computing device.

The instructions 508 may include detecting instructions. For example, the instructions 508 may detect a changed connection to a current generation interface from a current generation memory device to a previous generation carrier. For example, the interface may be a PCIe interface that includes a plurality of slots. Each of the slots may be a current generation slot (e.g., a Gen4 slot that operates with protocols that use a highest available data transfer rate associated with Gen4 slots).

However, to make some current generation memory devices portable or usable as an expansion drive, the current generation memory device may be placed in a carrier. Unfortunately, the carriers use a previous generation data transfer rate (e.g., a Gen3 carrier) that is different than the data transfer rates used by the current generation slots of the interface.

When a previous generation carrier is inserted into a current generation interface, the change may be detected. For example, during a BIOS boot sequence, the repeater ID of the previous generation carrier may be read to detect that a previous generation carrier is connected to the current generation interface.

The instructions 510 may include instructing instructions. For example, the instructions 510 may instruct the BIOS to re-train the current generation interface to change an operating speed associated with a current generation memory device to an operating speed associated with the previous generation carrier. For example, the current generation interface may be trained to operate at the slower data rate transfer speeds associated with the older generation carrier. Thus, the current generation interface may be modified to work with the previous generation carrier to avoid any data transfer errors or malfunctions.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
an interface;
a previous generation carrier connected to the interface, wherein the previous generation carrier includes a current generation memory card;
a controller communicatively coupled to the interface to detect the previous generation carrier; and
a basic input/output system (BIOS) to set the interface to operate at a speed associated with the previous generation carrier in response to a detection of the previous generation carrier.

2. The apparatus of claim 1, wherein the interface comprises a peripheral component interconnect express (PCIe) interface.

3. The apparatus of claim 2, wherein the controller comprises an embedded controller connected to the PCIe interface.

4. The apparatus of claim 3, wherein the embedded controller detects the previous generation carrier using a system management bus (SMBus).

5. The apparatus of claim 1, wherein the controller is to detect the previous generation carrier, and the BIOS is to set the interface to operate at speeds associated with the previous generation carrier when the apparatus is booted up.

6. The apparatus of claim 1, wherein the controller detects the previous generation carrier by reading an identification of a repeater.

7. The apparatus of claim 1, the apparatus further comprising:
a redriver coupled to the interface;
a cable connected to the redriver and to the previous generation carrier.

8. The apparatus of claim 1, wherein the previous generation carrier operates at read/write speeds associated with a third generation non-volatile memory express memory card.

9. The apparatus of claim 1, wherein the current generation memory card comprises a fourth generation non-volatile memory express memory card.

10. A method, comprising:
booting, by a processor, a basic input/output system (BIOS) of a computing device;
detecting, by the processor, a previous generation carrier connected to a current generation interface; and
instructing, by the processor, the BIOS to train the current generation interface to operate at a speed associated with the previous generation carrier.

11. The method of claim 10, wherein the detecting comprises:
reading, by the processor, an identification of a repeater connected to the current generation interface.

12. The method of claim 10, wherein the previous generation carrier is connected to a current generation non-volatile memory express memory card.

13. The method of claim 10, wherein the speed associated with the previous generation carrier comprises a read speed of less than 3500 megabytes per second and a write speed up to 3300 megabytes per second.

14. The method of claim 10, wherein the current generation interface is set to operate at a read speed of less than 3500 megabytes per second (MB/s) and a write speed up to 3300 MB/s from a maximum read speed of up to 5000 MB/s and a maximum write speed of up to 4400 MB/s.

15. The method of claim 10, further comprising:
powering down, by the processor, the computing device;
booting, by the processor, the BIOS of the computing device;
detecting, by the processor, a current generation memory device connected to the current generation interface; and
instructing, by the processor, the BIOS to train the current generation interface to operate at a speed associated with the current generation memory device.

16. A non-transitory computer readable storage medium encoded with instructions which, when executed, cause a processor of a computing device to:
boot a basic input/output system (BIOS) of the computing device;
detect a changed connection to a current generation interface from a current generation memory device to a previous generation carrier; and
instruct the BIOS to re-train the current generation interface to change an operating speed associated with a current generation memory device to an operating speed associated with the previous generation carrier.

17. The non-transitory computer readable storage medium of claim 16, wherein the changed connection is detected by reading an identification of a repeater connected to the previous generation carrier.

18. The non-transitory computer readable storage medium of claim 16, wherein the previous generation carrier comprises a frame card and a carrier card to receive the current generation memory device.

19. The non-transitory computer readable storage medium of claim 16, wherein the current generation memory device comprises a fourth generation non-volatile memory express (NVMe) memory card.

20. The non-transitory computer readable storage medium of claim 16, wherein the previous generation carrier operates at speeds associated with a third generation non-volatile memory express (NVMe) memory card.
